(19) United States
(12) Patent Application Publication
(10) Pub. No.: US 2010/0045793 A1
(43) Pub. Date: Feb. 25, 2010

(54) SHOCK ABSORBING FACILITY MONITORING SYSTEM AND APPARATUS FOR VEHICLES

(76) Inventors: Young Wan JI, Seoul (KR); Young Ho CHOI, Seoul (KR)

Correspondence Address: IPLA P.A., 3550 WILSHIRE BLVD., 17TH FLOOR, LOS ANGELES, CA, 90010, US

(21) Appl. No.: 12/512,605

(22) Filed: Jul. 30, 2009

(30) Foreign Application Priority Data
Aug. 25, 2008 (KR) 10-2008-0083015

(51) Int. Cl. H04N 7/18; G01M 17/00

(52) U.S. Cl. 348/143; 73/11.04; 348/E07.085

(57) ABSTRACT

Provided is a shock absorbing facility monitoring system and a shock absorbing facility monitoring apparatus for vehicles, where when a vehicle collides with a shock absorbing facility, the situation before and after the collision is photographed, and the photographed signals are transmitted to a main control center in a wireless transmission method. The shock absorbing facility monitoring system for vehicles comprises: shock absorbing facility monitoring apparatuses installed within a certain distance from the shock absorbing facility; an information communication network for transmitting the vehicle approach signal and the video signal transmitted from the plurality of shock absorbing facility monitoring apparatuses to a remote site; and a central control apparatus installed at a main control center.

### CROSS REFERENCES

This application claims foreign priority under Paris Convention to Korean Patent Application No. 10-2008-0083015, filed Aug. 25, 2008 with the Korean Intellectual Property Office.

### BACKGROUND OF THE INVENTION

1. Field of the Invention

The present invention relates to a shock absorbing facility monitoring system and a shock absorbing facility monitoring apparatus for vehicles. More specifically, the present invention relates to a shock absorbing facility monitoring system and a shock absorbing facility monitoring apparatus for vehicles, in which when a vehicle collides with a shock absorbing facility, which is a shock absorbing device installed on the road, the situation before and after the collision is photographed, and the photographed signals are transmitted to a main control center in a wireless transmission method, so that a manager of the main control center can correctly grasp the collision situation and determine whether the shock absorbing facility is damaged at the moment of the collision to take actions appropriate to the situation.

2. Background of the Related Art

Generally, when a vehicle moves out of a driving lane, a shock absorbing apparatus absorbs impact energy of the vehicle to stop the vehicle before the vehicle collides with a structure or the like constructed on the road or corrects the driving direction of the vehicle to return the vehicle to the driving lane where the vehicle was driving. The shock absorbing apparatuses are installed at highway junctions and the like to protect interchanges and junctions of highways, entrances of tunnels or underground roads, bridge piers, and bridge posts.

The shock absorbing apparatus described above is an object that is collided with the vehicle moving out of the driving lane in the first place, which will be damaged if shocks are repeatedly applied however weak the shocks may be.

The shock absorbing apparatuses damaged as described above have a problem in that the vehicle moving out of the driving lane cannot be protected from the firsthand danger.

Furthermore, since the shock absorbing apparatuses have been installed on a large number of roads presently, there is a problem in that if managers or supervisors examine whether the shock absorbing apparatuses are damaged, a lot of manpower and managing time is required.

### SUMMARY OF THE INVENTION

Therefore, the present invention has been made in view of the above problems, and it is an object of the present invention to provide a shock absorbing facility monitoring system and a shock absorbing facility monitoring apparatus for vehicles, in which when a vehicle collides with a shock absorbing facility, which is a shock absorbing device installed on the road, the situation before and after the collision is photographed, and the photographed signals are transmitted to a main control center in a wireless transmission method, so that a manager of the main control center can correctly grasp the collision situation and determine whether the shock absorbing facility is damaged at the moment of the collision to take actions appropriate to the situation.

To accomplish the above object, in an embodiment of the present invention, there is provided a shock absorbing facility monitoring system for vehicles, the system comprising: a plurality of shock absorbing facility monitoring apparatuses installed within a certain distance from a shock absorbing facility, for generating and outputting a vehicle approach signal when a vehicle approaches within a predetermined distance and outputting a video signal photographing the vehicle; an information communication network for transmitting the vehicle approach signal and the video signal transmitted from the plurality of shock absorbing facility monitoring apparatuses to a remote site; and a central control apparatus installed at a main control center, for receiving the vehicle approach signal and the video signal transmitted through the information communication network, displaying the vehicle approach signal and the video signal on a screen, storing the vehicle approach signal and the video signal in a storage apparatus, and transmitting the vehicle approach signal and the video signal to a predetermined terminal of a manager.

In another embodiment of the present invention, there is provided a shock absorbing facility monitoring apparatus for vehicles, the apparatus comprising: a power supply apparatus formed with solar cells, for charging the solar cells by transforming sunlight into an electrical signal and supplying the charged power as driving power; an approach recognition apparatus provided with an infrared sensor or a supersonic sensor, for outputting a vehicle approach signal when the infrared or supersonic sensor senses approach of a vehicle within a predetermined distance; a photographing apparatus connected to the approach recognition apparatus, for photographing the vehicle in response to the vehicle approach signal of the approach recognition apparatus and outputting a corresponding video signal; a control box for receiving and storing the vehicle approach signal outputted from the approach recognition apparatus and the video signal outputted from the photographing apparatus, outputting the stored video signal outside, and transmitting the stored video signal to a mobile terminal connected from outside through intercommunication with the mobile terminal; and a control box monitoring apparatus installed on a top of the control box, for monitoring the control box in real time.

### BRIEF DESCRIPTION OF THE DRAWINGS

FIG. 1 is a view showing a shock absorbing facility monitoring system for vehicles installed at a field according to the present invention.

FIG. 2 is a view showing the configuration of a shock absorbing facility monitoring system for vehicles according to the present invention.

FIG. 3 is a view showing the configuration of a shock absorbing facility monitoring apparatus applied to FIG. 1.

FIG. 4 is a view showing the configuration of a central control apparatus applied to FIG. 1.

### DETAILED DESCRIPTION OF THE PREFERRED EMBODIMENT

A preferred embodiment of the invention will be hereafter described in detail, with reference to the accompanying drawings.

### First Embodiment: A Shock Absorbing Facility Monitoring System for Vehicles

A shock absorbing facility monitoring system for vehicles applied to the present invention comprises: a plurality of shock absorbing facility monitoring apparatuses 100 installed within a certain distance from a shock absorbing facility, for generating and outputting a vehicle approach signal when a vehicle approaches within a predetermined distance and outputting a video signal photographing the vehicle; an information communication network 200 for transmitting the vehicle approach signal and the video signal transmitted from the plurality of shock absorbing facility monitoring apparatuses to a remote site; a central control apparatus 300 installed at a main control center, for receiving the vehicle approach signal and the video signal transmitted through the information communication network, displaying the vehicle approach signal and the video signal on a screen, storing the vehicle approach signal and the video signal in a storage apparatus, and transmitting the vehicle approach signal and the video signal to a predetermined terminal of a manager; and a control box monitoring unit 400 installed on a top of the control box, for photographing the control box, converting a photographed signal to a control box breakdown monitoring signal, and storing the control box breakdown monitoring signal.

The shock absorbing facility monitoring apparatus 100 includes: an approach recognition unit 110 for recognizing approach of the vehicle and transmitting the vehicle approach signal when the vehicle approaches within a predetermined distance; an approach monitoring unit 120 for outputting the vehicle approach signal to a control box 150 described below and outputting a photographing control signal when the vehicle approach signal is received from the approach recognition unit 110; a photographing unit 130 for photographing an object in response to the photographing control signal of the approach monitoring unit 120, converting the photographed object into a photograph signal, i.e., an electrical signal, and outputting the photograph signal; a signal processing unit 140 for generating and transmitting a video signal by processing the photograph signal received from the photographing unit 130 and storing the transmitted video signal; the control box 150 for storing the vehicle approach signal and the video signal received from the approach monitoring unit 120 and the signal processing unit 140 and transmitting the stored vehicle approach and video signals outside through a transmit and receive unit 190; a power supply apparatus 160 provided with a solar cell battery, for supplying voltage charged in the solar cell battery as driving power; an interface unit 170 connected to an external apparatus, for transmitting the vehicle approach and video signals from the control box 150 to the external apparatus; and a storage unit 180 for storing the vehicle approach and video signals in response to a control of the control box 150.

The information communication network includes wired or wireless communication networks such as Internet, WAP, CDMA network, and the like.

The central control apparatus 300 includes: a transmit and receive unit 310 for receiving the vehicle approach and video signals transmitted from the shock absorbing facility monitoring apparatuses 100; a control unit 320 for storing the vehicle approach and video signals, displaying the vehicle approach and video signals on a screen, transmitting an acknowledge message to a predetermined terminal of a manager, and determining whether the shock absorbing facility monitoring apparatus 100 normally operates by transmitting a normal operation confirmation signal to the shock absorbing facility monitoring apparatus 100 at regular intervals and checking whether a response thereof is received; a storage unit 330 for storing the vehicle approach and video signals by the shock absorbing facility monitoring apparatus 100 in response to a control of the control unit 320; a mobile communication unit 340 for transmitting the acknowledge message to the terminal of the manager in response to a control of the control unit 320; and a wired communication unit 350 for coping with an abnormal situation such as a malfunction of a wireless communication system and allowing the manager to manually check the shock absorbing facility monitoring system for vehicles.

The operation of the shock absorbing facility monitoring system for vehicles configured as described above is described below.

The approach recognition unit 110 formed with an infrared sensor or a supersonic sensor generates a vehicle approach signal and outputs the vehicle approach signal to the approach monitoring unit 120 when a vehicle running on a road moves out of the driving lane, dashes toward the shock absorbing facility, and approaches the shock absorbing facility within a predetermined distance.

Then, the approach monitoring unit 120 outputs the vehicle approach signal to the control box 150, and generates and outputs a photographing control signal to the photographing unit 130. In response, the photographing unit 130 photographs the dashing vehicle and outputs a photograph signal to the signal processing unit 140, and the signal processing unit 140 performs a signal processing so that the photograph signal can be converted into a video signal that is displayed on a screen for a user to view the video images and transmits the video signal to the control box 150.

The control box 150 stores the inputted video signal in the storage unit 180 and transmits the video signal to the input and output unit 190. The input and output unit 190 converts the video signal, together with identification information of the shock absorbing facility, into a wireless signal and transmits the wireless signal.

The shock absorbing facility monitoring system charges a rechargeable battery by transforming sunlight into an electrical signal using a solar cell battery and allows each constitutional component to operate using the charged power. The power supply apparatus 160 having the solar cell battery can operate the shock absorbing facility monitoring system for three days using the power recharged for one sunny day.

The shock absorbing facility monitoring system further comprises a control box monitoring apparatus 400 for monitoring the control box 150, in addition to a camera for photographing a vehicle. The control box monitoring apparatus 400 is a CCTV, which is a constitutional component for monitoring breakage of the control box 150 caused by a physical force applied from outside. The control box monitoring apparatus 400 continuously photographs the control box 150 and stores photographed video signals so that reasons of the breakage can be easily grasped and actions corresponding to the breakage can be taken when the control box 150 is broken down.

In addition, since the shock absorbing facility monitoring apparatus 100 further comprises an interface unit 170 for connecting an external device such as a notebook computer or the like, managers can visit a scene, connect a mobile external device such as a notebook computer or the like to the interface unit 170 of the shock absorbing facility monitoring apparatus 100, and download and manage the vehicle approach signal and video signal stored in the storage unit 190 by performing intercommunication with the control box 150. In addition, the interface unit makes it easy to change communication environments for transmitting the operating system of the control box 150, the vehicle approach signal, and the video signal.

On the other hand, the control unit 320 of the central control apparatus 300 installed at a remote site receives the vehicle approach signal transmitted from at least one of the shock absorbing facility monitoring apparatuses 100 and video signals containing photographs of a dashing vehicle through the transmit and receive unit 310 and displays the vehicle approach and video signals on the screen of a display unit (not shown) so that the managers at the main control center of the remote site may confirm the situation.

The control unit 320 stores and manages the vehicle approach and video signals displayed on the screen into the storage unit 330 and transmits the vehicle approach and video signals to a cellular phone or PDA, which is a previously registered terminal of a manager, through the mobile communication unit 340 to inform the manager of the approach of the vehicle so that the manager may promptly repair the shock absorbing facility to prevent an accident that can occur in the future.

Since the vehicle approach and video signals are stored in the storage unit 330 by the time in connection with identification information of the shock absorbing facility monitoring apparatus 100, they can be easily confirmed even after a certain period of time. Since all the images before and after an accident are photographed and stored as video signals, they can be used as a material for correctly analyzing the causes of the accident in the case of an accident.

On the other hand, the control unit 320 of the central control apparatus 300 determines whether the shock absorbing facility monitoring apparatus 100 normally operates by transmitting a normal operation confirmation signal to the shock absorbing facility monitoring apparatus 100 at regular intervals and checking whether a response thereof is received. If the shock absorbing facility monitoring apparatus abnormally operates as a result of the determination, the control unit transmits identification information of the abnormally operating shock absorbing facility monitoring apparatus 100, together with an operation check message, to a terminal of a corresponding manager so that the manager may examine the shock absorbing facility monitoring apparatus 100.

Finally, the control unit 320 of the central control apparatus 300 receives the vehicle approach signal and the video signal photographing a dashing vehicle from the shock absorbing facility monitoring apparatus 100, calculating the speed of the vehicle based on the vehicle approach signal, and determines whether it is a kind of vehicle by confirming the existence of a license plate, steering wheel, headlights, or the like. If it is a vehicle and the speed of the vehicle exceeds a speed limit as a result of the determination, the situation is classified as an emergency state, and the control unit transmits an emergency state notification message to the terminal of the corresponding manager. The emergency state notification message includes the identification information of the shock absorbing facility monitoring apparatus 100 so that the manager can easily grasp the scene of the accident.

### Second Embodiment: A Shock Absorbing Facility Monitoring Apparatus for Vehicles

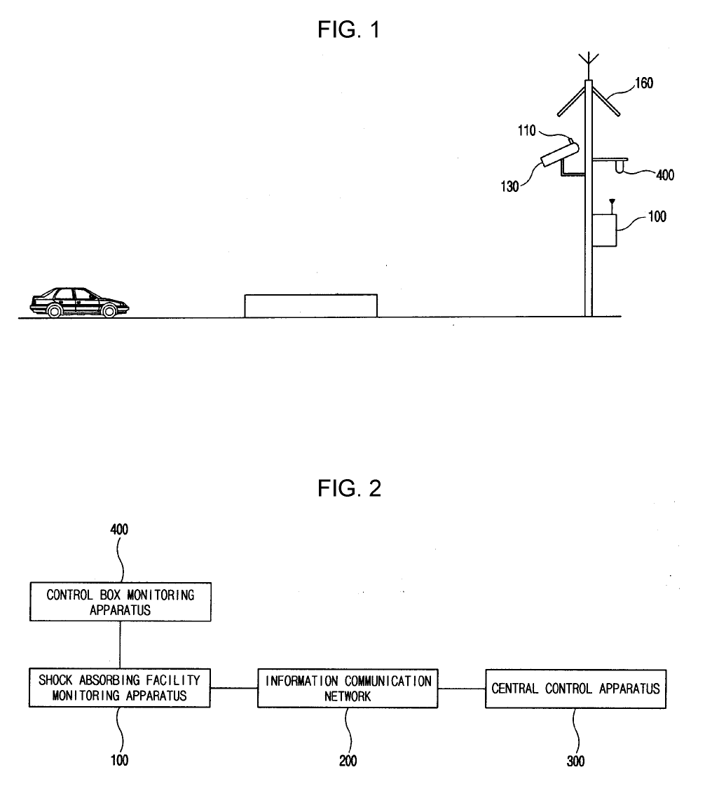

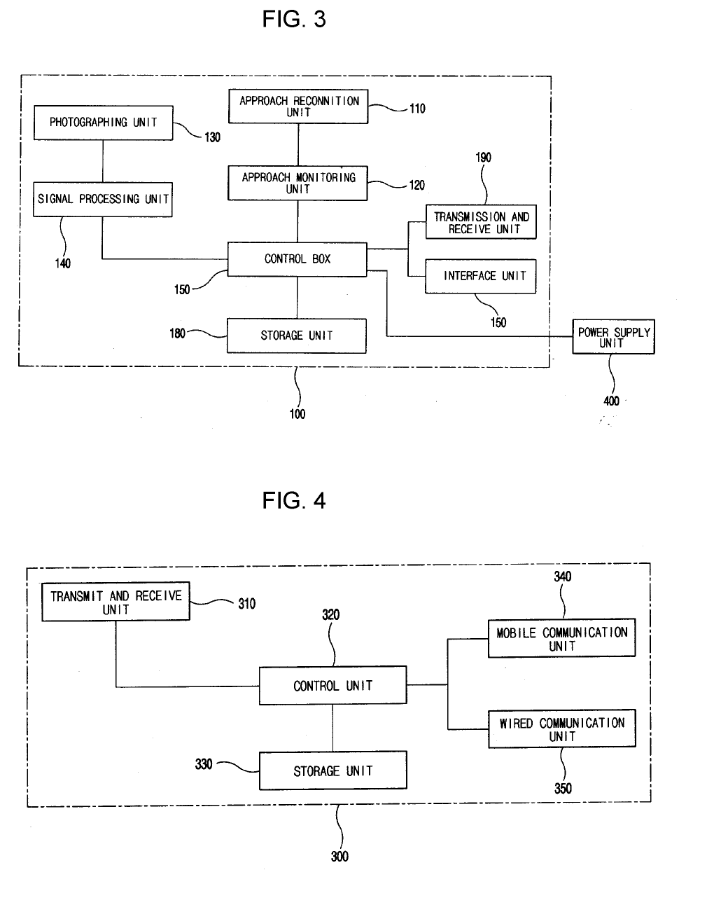

As shown in FIG. 1, a shock absorbing facility monitoring apparatus for vehicles according to the present invention comprises: a power supply apparatus 160 formed with solar cells, for charging the solar cells by transforming sunlight into an electrical signal and supplying the charged power as driving power; an approach recognition apparatus 110 provided with an infrared sensor or a supersonic sensor, for outputting a vehicle approach signal when the infrared or supersonic sensor senses approach of a vehicle within a predetermined distance; a photographing apparatus 130 connected to the approach recognition apparatus 110, for photographing the vehicle in response to the vehicle approach signal of the approach recognition apparatus 110 and outputting a corresponding video signal; a control box 150 for receiving and storing the vehicle approach signal outputted from the approach recognition apparatus 110 and the video signal outputted from the photographing apparatus 130, outputting the stored video signal outside, and transmitting the stored video signal to a mobile terminal connected from outside through intercommunication with the mobile terminal; and a control box monitoring apparatus 400 installed on a top of the control box 150, for monitoring the control box 150 in real time.

Since the operation of the shock absorbing facility monitoring apparatus configured as described above is the same as that of embodiment 1 and only the names of the constitutional components are slightly different from those of embodiment 1, it will not be described in detail.

Therefore, the present invention is effective in that when a vehicle collides with a shock absorbing facility, which is a shock absorbing device installed on the road, the situation before and after the collision is photographed, and the photographed signals are transmitted to a main control center in a wireless transmission method, so that a manager of the main control center can correctly grasp the collision situation and determine whether the shock absorbing facility is damaged at the moment of the collision to take actions appropriate to the situation.

Furthermore, the present invention is effective in that a low consumption strategy can be implemented by using a solar heat battery as a power supply.

Furthermore, the present invention is effective in that damages incurred by an accident can be minimized by correctly grasping the situation of the accident using the photograph data transmitted to the main control center and immediately transmitting information on the disaster to a rescue team such as a 911 team or the like.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A shock absorbing facility monitoring system for vehicles, the system comprising:
a plurality of shock absorbing facility monitoring apparatuses installed within a certain distance from a shock absorbing facility, for generating and outputting a vehicle approach signal when a vehicle approaches within a predetermined distance and outputting a video signal photographing the vehicle;
an information communication network for transmitting the vehicle approach signal and the video signal transmitted from the plurality of shock absorbing facility monitoring apparatuses to a remote site; and
a central control apparatus installed at a main control center, for receiving the vehicle approach signal and the video signal transmitted through the information communication network, displaying the vehicle approach signal and the video signal on a screen, storing the vehicle approach signal and the video signal in a storage apparatus, and transmitting the vehicle approach signal and the video signal to a predetermined terminal of a manager.

2. The system according to claim 1, wherein the shock absorbing facility monitoring apparatus includes:
an approach recognition unit for recognizing approach of the vehicle and transmitting the vehicle approach signal when the vehicle approaches within a predetermined distance;
an approach monitoring unit for outputting the vehicle approach signal and a photographing control signal when the vehicle approach signal is received from the approach recognition unit;
a photographing unit for photographing an object in response to the photographing control signal of the approach monitoring unit, converting the photographed object into a photograph signal, i.e., an electrical signal, and outputting the photograph signal;
a signal processing unit for processing the photograph signal received from the photographing unit into a video signal, transmitting the video signal, and storing the transmitted video signal; and
a control box for storing the vehicle approach signal and the video signal received from the approach monitoring unit and the signal processing unit and transmitting the stored vehicle approach and video signals outside through a transmit and receive unit.

3. The system according to claim 2, wherein the shock absorbing facility monitoring apparatus further includes a power supply apparatus provided with a solar cell battery, for supplying voltage charged in the solar cell battery as driving power.

4. The system according to claim 2, wherein the shock absorbing facility monitoring apparatus further includes an interface unit connected to an external apparatus, for transmitting the vehicle approach and video signals from the control box to the external apparatus.

5. The system according to claim 1, further comprising a control box monitoring apparatus installed on a top of the control box, for photographing the control box, converting a photographed signal to a control box breakdown monitoring signal, and storing the control box breakdown monitoring signal.

6. The system according to claim 1, wherein the central control apparatus includes:
a transmit and receive unit for receiving the vehicle approach and video signals transmitted from the shock absorbing facility monitoring apparatuses;
a control unit for storing the vehicle approach and video signals, displaying the vehicle approach and video signals on a screen, and transmitting an acknowledge message to a terminal of a corresponding manager;
a storage unit for storing the vehicle approach and video signals by the shock absorbing facility monitoring apparatus in response to a control of the control unit; and
a mobile communication unit for transmitting the acknowledge message to the terminal of the manager in response to a control of the control unit.

7. The system according to claim 1, wherein the central control apparatus further includes a wired communication unit for coping with an abnormal situation such as a malfunction of a wireless communication system and allowing the manager to manually check the shock absorbing facility monitoring system for vehicles.

8. The system according to claim 6, wherein the control unit determines whether the shock absorbing facility monitoring apparatus 100 normally operates by transmitting a normal operation confirmation signal to the shock absorbing facility monitoring apparatus 100 at regular intervals and checking whether a response thereof is received.

9. A shock absorbing facility monitoring apparatus for vehicles, the apparatus comprising:
a power supply apparatus formed with solar cells, for charging the solar cells by transforming sunlight into an electrical signal and supplying the charged power as driving power;
an approach recognition apparatus provided with an infrared sensor or a supersonic sensor, for outputting a vehicle approach signal when the infrared or supersonic sensor senses approach of a vehicle within a predetermined distance;
a photographing apparatus connected to the approach recognition apparatus, for photographing the vehicle in response to the vehicle approach signal of the approach recognition apparatus and outputting a corresponding video signal;
a control box for receiving and storing the vehicle approach signal outputted from the approach recognition apparatus and the video signal outputted from the photographing apparatus, outputting the stored video signal outside, and transmitting the stored video signal to a mobile terminal connected from outside through intercommunication with the mobile terminal; and
a control box monitoring apparatus installed on a top of the control box, for monitoring the control box in real time.
